(19) United States
(12) Patent Application Publication
(10) Pub. No.: US 2022/0177624 A1
(43) Pub. Date: Jun. 9, 2022

(54) POLYMER NETWORKS WITH UNIQUE PROPERTIES

(71) Applicant: UNIVERSITY OF IOWA RESEARCH FOUNDATION, Iowa City, IA (US)

(72) Inventors: Erion Hasa, Iowa City, IA (US); C. Allan Guymon, Iowa City, IA (US)

(73) Assignee: UNIVERSITY OF IOWA RESEARCH FOUNDATION, Iowa City, IA (US)

(21) Appl. No.: 17/541,056

(22) Filed: Dec. 2, 2021

Related U.S. Application Data
(60) Provisional application No. 63/122,647, filed on Dec. 8, 2020.

(51) Int. Cl. C08F 222/10; C08F 220/18; C08F 220/20

(52) U.S. Cl. CPC C08F 222/102; C08F 220/20; C08F 220/1804

(57) ABSTRACT

A composition comprising a crosslinked polymer network and one or more oligomers that are substituted with one or more polar groups. The compositions are useful in the manufacture of furniture, flooring, optical fibers, information storage media, dental devices and implants, printing inks, 3D printing, adhesives, biomaterials, and optical lenses (e.g. contact lenses).

### PRIORITY

This application claims priority to United States Provisional Application No. 63/122,647 that was filed on 8 Dec. 2020. The entire content of application referenced above is hereby incorporated by reference herein.

### BACKGROUND

The formation of materials with nano/micro-structured domains have shown a variety of different properties including controlled toughness, strength, ion conductivity, and roughness (Ligon-Auer, S. C. et al. Polym. Chem. 2016, 7 (2), 257-286; Schulze, M. W. et al. High-Modulus, High-Conductivity Nanostructured Polymer Electrolyte Membranes via Polymerization-Induced Phase Separation. 2014 and Szczepanski, C. R. et al. ACS Appl. Mater. Interfaces 2016, 8 (5), 3063-3071). Previous studies have shown that polymer morphology and properties can be controlled using photo-induced phase separation, incorporating nanofillers in polymer composites, and in block copolymers (Hasa, E. et al. Macromolecules 2019, 52 (8), 2975-2986; Scholte, J. P. et al. J. Polym. Sci. Part A Polym. Chem. 2017, 55 (1), 144-154; Siddhamalli, S. K. et al. J. Appl. Polym. Sci. 2000, 77, 1257-1268 and Bhattacharya, M. Polymer Nanocomposites-A Comparison between Carbon Nanotubes, Graphene, and Clay as Nanofillers. Materials. 2016, 9 (4), 1-35). For example, photocuring systems with acrylates and oxetanes at a specific monomer ratio resulted in various phase-separated domains that enabled better control over the thermomechanical properties (e.g. glass transition temperature (T_{g}), elongation at break, and toughness (Hasa, E. et al. Macromolecules 2019, 52 (8), 2975-2986).

It has been shown that the incorporation of nanofillers (e.g. graphene oxide and calcium carbonate) can lead to fabrication of lightweight polymer composites with significantly increased T_{g}, modulus, and yield stress (Jordan, J. et al. Mater. Sci. Eng. A 2005, 393 (1-2), 1-11 and Martin-Gallego, M. et al. Polymer. 2011, 52 (21), 4664-4669). Additionally, manipulating the architecture of oligomers has enabled better control of reaction kinetics, polymer morphology, and mechanical properties (Liu, Y. J. Appl. Polym. Sci. 2013, 127 (5), 3279-3292). For example, thermoplastic triblock (ABA) oligomers with soft and hard domains induce macrophase separation. With lower concentration of the hard domain, morphologies with spherical glassy domains surrounded by a more elastic network were formed leading to increased elongation at break. On the other hand, increasing hard domain concentration enabled formation of co-continuous glassy/rubbery domains resulting in enhanced Young's modulus (Crawford, K. E. et al. ACS Macro Lett. 2015, 4 (9), 921-925).

Other studies have shown that changing the oligomer architecture (e.g. triblock, random, and V-shaped gradient) can lead to significantly different phase-separated morphologies and properties (Guo, Y. et al. J. Polym. Sci. Part B Polym. Phys. 2015, 53 (12), 860-868). For example, block and gradient oligomers demonstrated co-continuous domains that enable significant increases in elongation at break while random oligomers formed single-domain structures with enhanced elastic modulus.

Furthermore, photopolymerization of urethane-based reactive oligomers has been used to control reaction rate and conversion, as well as to generate polymer networks with significantly higher thermal stability, water absorption, and strength (Kayaman-Apohan, N. et al. Prog. Org. Coatings 2004, 49 (1), 23-32). More recent work has also shown that photopolymerization of cationic resins modified with epoxy-functionalized oligomers of varying architecture results in the formation of different nano/micro-structured polymers with controlled cross-linked density and T_{g}'s, as well as increased elongation at break. These changes were all associated with the average number molecular weight (Mₙ) and concentration of oligomers that impact oligomer-network interactions (Scholte, J. P. et al. J. Polym. Sci. Part A Polym. Chem. 2017, 55 (1), 144-154).

Consequently, it is reasonable to assume that modifying the molecular weight, functionality, backbone chains, and pendant groups in custom-synthesized oligomers could lead to controlled polymerization kinetics, polymer morphology, and thermomechanical properties which may be useful for a variety of applications (Szczepanski, C. R. et al. Polymer. 2012, 53 (21), 4694-4701; Szczepanski, C. R. et al. Polymer. 2015, 70, 8-18 and Scholte, J. Effects of Prepolymer Structure on Photopolymer Network Formation and Thermomechanical Properties, University of Iowa, 2017). It is therefore of great importance to control the nano/microstructure of photocurable materials that will enable new and beneficial thermomechanical properties for novel and expanded use of photocurable systems.

### SUMMARY

Applicant has identified an alternative approach to generate polymer materials with new and beneficial properties, including for example, improved mechanical and physical properties. This work examines the incorporation of custom-synthesized oligomers into radically-photopolymerized diacrylate systems to influence polymer structure development and the interactions between the acrylate cross-linked network and the linear oligomers. The placement of OH groups on the backbone chain was changed in order to examine the effect on photo-induced phase separation and thermomechanical properties at different environmental temperatures. Specifically, the OH groups were either located at both ends or randomly distributed along the oligomer chain. Controlled radical polymerization was used to synthesize oligomers with butyl acrylate (BA) as the main chain (hydrophobic segment) and hydroxyethyl acrylate (HEA) to provide OH pendant groups (hydrophilic segment).

In this work, it was hypothesized that photopolymerization of hydrophilic diacrylate systems modified with OH-functionalized oligomers can induce different phase-separated morphologies by changing OH placement and oligomer chain length. It is expected that the Mₙ of oligomers and the resultant formulation viscosity will influence reaction kinetics and thus domain development during photopolymerization. Consequently, reaction rate as a function of conversion was determined for all oligomer-modified systems using differential scanning calorimetry. Additionally, the placement of OH groups will likely influence hydrogen bonding interactions between the linear oligomers and cross-linked acrylate network, impacting overall morphological development and thermomechanical properties. To investigate the variations in polymer morphologies imparted from the different oligomers, atomic force microscopy was used. The formation of phase-separated domains was confirmed by the presence of multiple tan (δ) peaks obtained using dynamic mechanical analysis (DMA). In addition, DMA was utilized to investigate other polymer properties including stress-strain, storage modulus, and tensile toughness at room and increased temperatures. Lastly, the effect of oligomer addition into a commercially available acrylate formulation on the performance of 3D printed object was investigated using impact testing. This work shows that photo-induced phase separation in acrylate systems modified with OH-functionalized oligomers can be used to fabricate polymers with distinct nano/micro-structured domains, contributing to improved toughness and impact strength. The incorporation of oligomers into a commercially available resin also indicates that these materials can be used for enhanced mechanical properties in 3D printing applications.

One embodiment provides a composition comprising a crosslinked polymer network and one or more oligomers that are substituted with one or more polar groups.

One embodiment provides a printable ink comprising a composition as described herein.

One embodiment provides an article of manufacture that comprises a composition as described herein.

One embodiment provides a method comprising: forming a crosslinked polymer network in the presence of one or more oligomers that are substituted with one or more polar groups to provide a final composition that comprises a polymer network and one or more oligomers that are substituted with one or more polar groups.

One embodiment provides a solution comprising acrylate, methacrylate, urethane acrylate, urethane methacrylate, acrylamide, methacrylamide, thiol, styrene, or vinyl ether monomers, and oligomers that are substituted with one or more polar groups.

The invention also provides processes and intermediates disclosed herein that are useful for preparing the compositions of the invention.

### BRIEF DESCRIPTION OF DRAWINGS

The patent or application file contains at least one drawing executed in color. Copies of this patent or patent application publication with color drawings will be provided by the Office upon request and payment of the necessary fee.

FIG. 1 shows the representation of oligomer structures with OH group placement on the a) end and b) randomly distributed on the BA chain. Both chemical structures are composed of a 4:1 (w/w) BA/HEA ratio.

FIG. 2 shows the normalized reaction rate as a function of acrylate group conversion for TTGDA (dashed line) systems modified with a) end-functionalized and b) random-functionalized oligomers. All formulations were composed of 2:1 (w/w) TTGDA/Oligomer with DMPA concentration of 0.5 wt %. Samples were photocured at 10 mW/cm² for 10 min.

FIG. 3 shows AFM phase image and distribution of a polymer system composed of neat TTGDA. The system was photopolymerized at 10 mW/cm² for 10 min. The dimensions of the polymer surface area are 1×1 μm. Photoinitiator DMPA concentration was 0.5 wt %.

FIG. 4 shows AFM phase images and distributions of polymer systems with 2:1 (w/w) a) TTGDA/E15k, b) TTGDA/E30k, and c) TTGDA/E50k. Samples were photopolymerized at 10 mW/cm² for 10 minutes using 0.5 wt % DMPA. The dimensions of each polymer surface area are 1×1 μm.

FIG. 5 shows AFM phase images and distributions of polymer systems with 2:1 (w/w) a) TTGDA/R15k, b) TTGDA/R30k, and c) TTGDA/R50k. Samples were photopolymerized at 10 mW/cm² for 10 minutes using 0.5 wt % DMPA. The dimensions of each polymer surface area are 1×1 μm.

FIG. 6 shows Tan (δ) and storage modulus profiles as a function of temperature for TTGDA systems modified with a) end-functionalized OH groups and b) random-functionalized OH groups oligomers. Samples are photopolymerized at 10 mW/cm² for 10 minutes using 0.5 wt % DMPA.

FIG. 7 shows the stress as a function of strain for TTGDA systems modified with a) end-functionalized and b) random-functionalized oligomers. Samples are photopolymerized at 10 mW/cm² for 10 minutes using 0.5 wt % DMPA.

FIG. 8 shows tensile toughness for a system with neat TTGDA (dark grey), and for systems modified with end-functionalized (red) and random-functionalized (blue) oligomers. Samples are photopolymerized at 10 mW/cm² for 10 minutes using 0.5 wt % DMPA. Each experiment was conducted 4 times with the error bars representing standard deviation.

FIG. 9 shows polymer toughness of systems with neat TTGDA and 2:1 (w/w) TTGDA/R15k at different temperatures. Samples are photopolymerized at 10 mW/cm2 for 10 minutes using 0.5 wt % DMPA. Each experiment was conducted 4 times with the error bars representing standard deviation.

FIG. 10 shows the impact strength for PR48 (grey) systems modified with end-functionalized (red), random-functionalized (blue) oligomers and CN9002 (green) oligomer. All photocurable systems are prepared with a 4:1 (w/w) PR48/Oligomer ratio. Each layer of all 3D printed objects was photopolymerized at approximately 20 mW/cm² using a 405 nm LED light source imparted in the Autodesk Ember 3D printer. The error bars represent the standard deviation of 5 experiments.

FIG. 11 shows photographs of 3D printed object after UV post-curing.

FIG. 12 shows Tan (δ) profiles as a function of temperature for PR48 systems modified with a) end-functionalized and b) random-functionalized oligomers. The system modified with CN9002 system is also included. Samples are photopolymerized at 20 mW/cm² for 10 minutes using 0.5 wt % TPO.

FIG. 13 shows Tan (δ) and storage modulus profiles as a function of temperature for HDDA systems modified with a) end-functionalized OH groups and b) random-functionalized OH groups oligomers. Samples are photopolymerized at 10 mW/cm² for 10 minutes using 0.5 wt % DMPA.

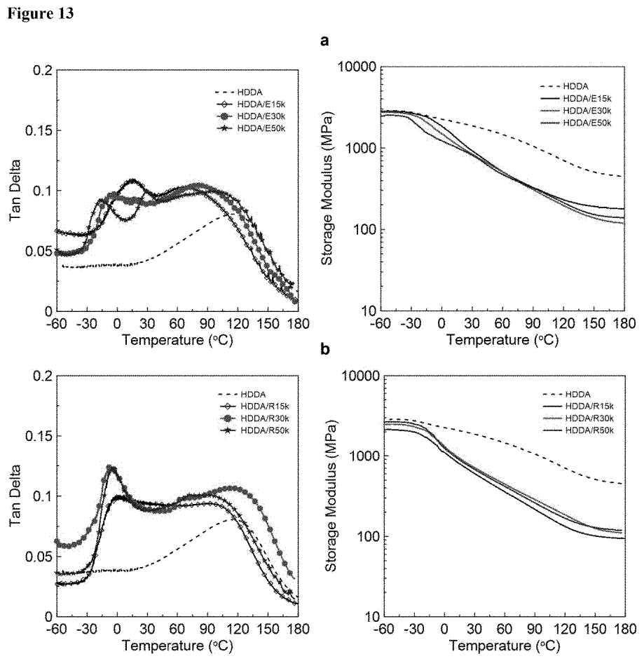

FIG. 14 shows the representation of possible oligomer rearrangements in the polymer networks.

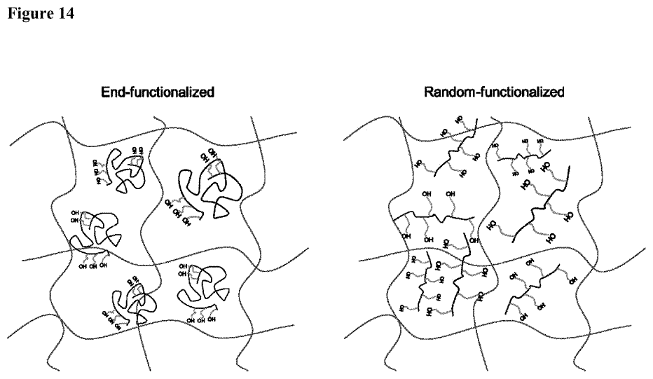

### DETAILED DESCRIPTION

The following definitions are used, unless otherwise described.

A “crosslinked polymer network” as used herein includes chains of molecules that are chemically bonded to each other to form a polymer with a permanent structure. For example, crosslinked polymer networks can be prepared from acrylates, methacrylates, urethane acrylates, urethane methacrylates, acrylamides, methacrylamides, thiols, styrenes, or vinyl ethers. The crosslinked polymer networks comprise domains that can encompass one or more oligomers. In one embodiment, the crosslinked polymer network is derivable by photochemically-induced polymerization. In one embodiment, the crosslinked polymer network is derivable by radical induced polymerization, cationic induced polymerization, thermal induced polymerization, or redox induced polymerization. In one embodiment, the crosslinked polymer network is derivable from polymerization of tetraethyleneglycol diacrylate.

A “polar group” as used herein includes a functional group that provides an oligomer that can modify or improve one or more physical property of the crosslinked polymer network.

In one embodiment, the polar group is selected from group consisting of hydroxy, mercapto, —NR₂, and —O—C(═O)—NR₂, wherein each R is independently selected from the group consisting of H and (C₁-C₆)alkyl.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, C₁-C₆)alkyl, (C₂-C₆)alkyl and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and higher homologs and isomers.

In one embodiment, the one or more oligomers each independently have a molecular weight in the range of from about 1000 amu to about 100,000 amu. In one embodiment, the one or more oligomers each independently have a molecular weight in the range of from about 10,000 amu to about 60,000 amu. In one embodiment, the one or more oligomers are each independently a block co-polymer. In one embodiment, the one or more oligomers are derivable from the polymerization of (C₁-C₈)alkyl acrylate and substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl. In one embodiment, the one or more oligomers are derivable from the polymerization of (C₁-C₈)alkyl acrylate and hydroxy(C₁-C₈)alkyl acrylate. In one embodiment, the one or more oligomers are derivable from the polymerization of butyl acrylate and hydroxyethyl acrylate. In one embodiment, the one or more oligomers are block co-polymers that are derivable from the polymerization of (C₁-C₈)alkyl acrylate and substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl; wherein the blocks derivable from the (C₁-C₈)alkyl acrylate make up from about 10% to about 90% of the oligomer by weight and the blocks derivable from the substituted (C₁-C₈)alkyl acrylate make up from about 10% to about 90% of the oligomer by weight.

In one embodiment, the blocks derivable from the (C₁-C₈)alkyl acrylate make up from about 40% to about 80% of the oligomer by weight and the blocks derivable from the substituted (C₁-C₈)alkyl acrylate make up from about 20% to about 60% of the oligomer by weight.

In one embodiment, the blocks derivable from the (C₁-C₈)alkyl acrylate make up from about 60% to about 80% of the oligomer by weight and the blocks derivable from the substituted (C₁-C₈)alkyl acrylate make up from about 20% to about 40% of the oligomer by weight.

In one embodiment, each oligomer independently has the structure of formula (I):

(B)u(A)v(B)u(A)v(B)u(A)v(B)u(A)v(B)u(A)v(B)u(A)v(B)u(A)v(B)u(A)v(B)u (I)

wherein:

each B is derivable from (C₁-C₈)alkyl acrylate;

each A is derivable from a substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl;

each u is an integer from 0 to 50;

each v is an integer from 0 to 50; and

the sum of all u and all v together is less than 1000.

In one embodiment, each B is derivable from (C₁-C₈)alkyl acrylate and each A is derivable from hydroxy(C₁-C₈)alkyl acrylate. In one embodiment, each B is derivable from butyl acrylate and each A is derivable from hydroxyethyl acrylate.

In one embodiment, the composition has an impact strength that is at least about 2-times as great as the impact strength of the same crosslinked polymer in the absence of the one or more oligomers.

In one embodiment, the composition has an impact strength that is at least about 5-times as great as the impact strength of the same crosslinked polymer in the absence of the one or more oligomers.

In one embodiment, the composition has a tensile toughness that is at least about 5-times as great as the tensile toughness of the same crosslinked polymer in the absence of the one or more oligomers.

In one embodiment, the composition has a tensile toughness that is at least about 8-times as great as the tensile toughness of the same crosslinked polymer in the absence of the one or more oligomers.

In one embodiment, the composition has an elongation to break that is at least about 5-times as great as the elongation to break of the same crosslinked polymer in the absence of the one or more oligomers.

In one embodiment, the composition has an elongation to break that is at least about 8-times as great as the elongation to break of the same crosslinked polymer in the absence of the one or more oligomers.

In one embodiment, the printable ink is a 3D printable ink.

In one embodiment, the composition is provided as a coating on an article of manufacture or as a thin film. In one embodiment, the article of manufacture is selected from the group consisting of furniture, flooring, optical fibers, information storage media, dental devices and implants, adhesives, biomaterials, and optical lenses (e.g. contact lenses).

In one embodiment, a solution comprising acrylate, methacrylate, acrylamide, methacrylamide, or vinyl ether monomers and oligomers that are substituted with one or more polar groups is provided. The solution is useful for preparing compositions comprising crosslinked polymer networks as described herein.

The invention will now be illustrated by the following non-limiting Examples.

### EXAMPLES

### Example 1

Tetraethylene glycol diacrylate (TTGDA) and the reactive urethane diacrylate oligomer (CN9002) were provided by Sartomer. Butyl acrylate (BA) and 2-hydroxyethyl acrylate (HEA) were purchased from Sigma Aldrich and Alfa Aesar, respectively. A model acrylate formulation (PR48) appropriate for 3D printing was provided by Colorado Photopolymer Solutions. The composition of PR48 is provided by Autodesk which developed this formulation for Ember DLP/SLA 3D Printers (Autodesk. Autodesk Standard Clear Prototyping Resin (PR48). 2015, 48). As radical photoinitiator, the 2,2-dimethoxy-1,2-diphenylethan-1-one (DMPA, Ciba Specialty Chemicals) was used. It is important to note that PR48 uses diphenyl(2,4,6-trimethylbenzoyl)phosphine oxide (TPO) as radical photoinitiator. All chemicals were used as received.

### Synthesis

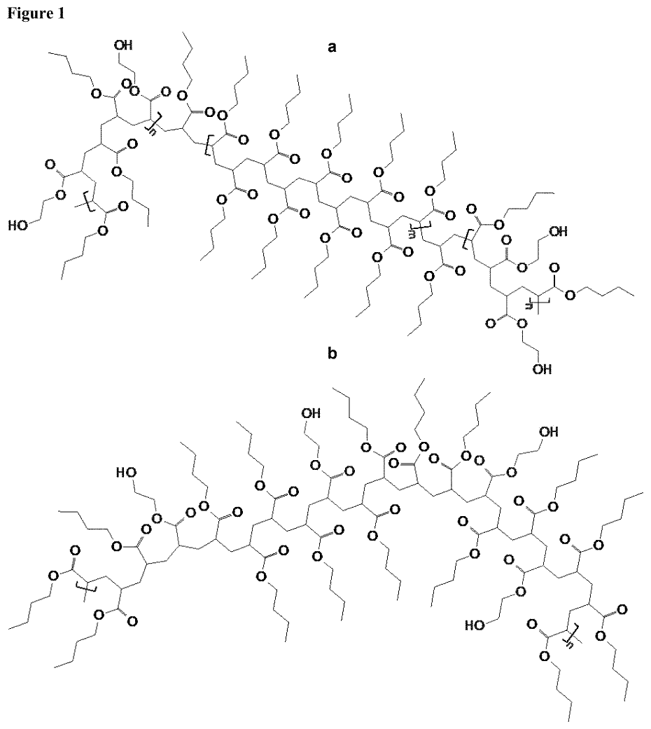

A versatile method to synthesize oligomers with controlled architecture is reversible addition-fragmentation chain transfer (RAFT) polymerization (Scholte, J. P. et al. J. Polym. Sci. Part A Polym. Chem. 2017, 55 (1), 144-154 and Keddie, D. J. Chem. Soc. Rev. 2014, 43 (2), 496-505). Production of oligomers via this method using common RAFT agents such as trithiocarbonates allows polymer network re-arrangements during UV illumination because the RAFT agents remain reactive (Fenoli, C. R. et al. Macromolecules 2014, 47 (3), 907-915). In this study, dibenzyl trithiocarbonate (DBTTC) was used for RAFT polymerization to prepare oligomers with different average number molecular weight (Mₙ) and architecture (FIG. 1). DBTTC was synthesized following a procedure described elsewhere (Naoto, A. et al. J. Polym. Sci. Part A Polym. Chem. 47 (14), 3702-3709). For the synthesis of oligomers with OH pendant groups, a similar procedure to Scholte et al. was followed (Scholte, J. P. et al. J. Polym. Sci. Part A Polym. Chem. 2017, 55 (1), 144-154). To place OH groups on the end sides of a BA backbone, a formulation composed of 4:4:1 (w/w/w) BA/ethyl acetate/HEA was introduced into a round bottom flask and heated at a temperature of approximately 100° C. A second feed with only BA diluted to 50 wt % ethyl acetate was then added to the reactor. On the other hand, a single mixture composed of 4:4:1 (w/w/w) BA/ethyl acetate/HEA was added to the reactor and allowed to polymerize at the same temperature in order to generate oligomers with OH groups placed randomly on the BA backbone.

The Mₙ of oligomers was controlled by changing the amount of azobisisobutyronitrile (AIBN) thermal initiator as shown in Table 1. In addition, a ratio of 10:1 (w/w) RAFT/AIBN was maintained for all mixtures. Each oligomer synthesis was conducted under a nitrogen environment for the entire polymerization. Once the desired Mₙ was achieved, as measured by gel permeation chromatography (GPC), the reaction was quenched by adding a small amount of AIBN and turning off the heat. All unreacted monomer and solvent were removed using a rotary evaporator for 1 hour at approximately 60° C.

TABLE 1
Properties of OH-modified oligomers used in this study.

| Sample | OH placement | AIBN (gr) | Mₙ (g/mol) | PDI |
|---|---|---|---|---|
| E15K | End | 0.12* | 15700 | 1.20 |
| E30K | End | 0.06* | 28500 | 1.10 |
| E50K | End | 0.04* | 48750 | 1.25 |
| R15K | Random | 0.12 | 16600 | 1.3 |
| R30K | Random | 0.06 | 30400 | 1.15 |
| R50K | Random | 0.04 | 48710 | 1.10 |

*the amount was split between the first and second feed.

### Methods

Photopolymerization kinetics were examined using a Perkin Elmer Diamond differential scanning calorimeter (DSC). To examine the heat flow during polymerization, approximately 2.5 mg were placed into a DSC pan and photocured at 10 mW/cm² using an external medium-pressure mercury arc lamp as a UV light source. Polymerization rates were normalized by the initial TTGDA concentration and determined using the evolved heat of polymerization per acrylate group according to Equation 1

$${R}_{p} = \frac{Q \times M W}{Δ H \times n \times m} \qquad ( 1 )$$

where Rₚ is the normalized rate of polymerization, Q is the heat flow as measured by the DSC, MW is the molecular weight of the monomer, ΔH is the enthalpy of reaction for an acrylate functional group (20.6 kcal/mol)(DePierro, M. A. et al. J. Polym. Sci. Part A Polym. Chem. 2016, 54 (1), 144-154), n is the number of reactive groups, and m is the mass of monomer in the sample.

Atomic force microscopy (AFM; Asylum Research Molecular Force Probe 3D Classic) was used to investigate polymer surface morphology. Phase images were obtained in tapping mode at a rate of 1 Hz and were analyzed with Igor software. A small amount of each monomer formulation was injected between two glass slides separated with 0.25 mm thick tape spacers. Thereafter, samples were photopolymerized at 10 mW/cm² for 10 min. One glass slide was removed to allow examination of the surface morphology.

Dynamic mechanical analysis (DMA; Q800 DMA TA Instruments) was used to investigate thermomechanical properties such as glass transition temperature, storage modulus, and stress as a function of strain. Small amounts of liquid mixture were photopolymerized at 10 mW/cm² between two glass slides separated by 0.25 mm thickness adhesive tape. The resulting polymer was then cut into rectangle shapes with dimensions of approximately 8×6×0.25 mm (L×W×T). DMA tensile mode was used under constant strain at a frequency of 1 Hz and a heating rate of 4° C./minute to observe the tan(6) behavior and obtain information regarding the glass transition temperature(s) and storage modulus. Additionally, stress as a function of strain was evaluated using DMA tensile mode with a force rate of 1.0 N/min. The initial slope and the area under stress and strain curves were calculated to estimate Young's modulus and toughness, respectively.

Thee impact strength of 3D printed systems composed of PR48 and different oligomers was determined using pendulum impact tester HIT5.5P (Zwick Roell). All tests were conducted using an Izod fixture at room temperature. The objects were fabricated using an Autodesk Ember digital light projection (DLP) 3D printer equipped with a DLP 0.45″ WXGA digital micromirror device and a 405 nm LED light source that produces approximately 20 mW/cm². More information regarding the operation of the 3D printer can be found elsewhere (Green, B. J. et al. Addit. Manuf. 2019, 27 (February), 20-31). The dimensions of each object were approximately 40×10×7 mm (L×W×T). In addition, all samples were notched to better examine the resistance to a sudden impact force.

The Mₙ and polydispersity index (PDI) of each oligomer were measured using multi-angle static light scattering (MALS; Dawn Heleos II) in conjunction with GPC. A small amount (20 μL) of oligomer diluted in tetrahydrofuran was injected in the GPC-MALS system and allowed to pass through a PLgel Mixed-D column at a flow rate of 0.5 mL/min.

All TTGDA systems were composed of 2:1 (w/w) TTGDA/oligomer using 0.5 wt % DMPA. Samples were photopolymerized at 10 mW/cm² for 10 minutes at room temperature (approximately 23° C.) using a high-pressure mercury arc lamp (Omnicure 51500 spot cure system) equipped with a 320-390 nm bandpass filter unless otherwise stated. For 3D printing experiments, however, systems with 4:1 (w/w) PR48/oligomer were used. PR48 was selected instead of TTGDA because of its suitability for 3D printing using DLP stereolithography and relatively good resolution and mechanical properties (Green, B. J. et al. Addit. Manuf. 2019, 27 (February), 20-31). In this case, a 405 nm LED light source was used to photocure each layer of approximately 50 μm thick at 20 mW/cm² for 3.5 s.

### Results and Discussion

Reaction Rate and Conversion

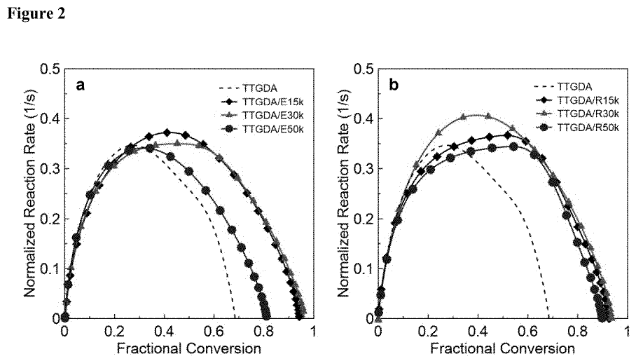

Photopolymerization can initiate reactions between photoinitiators and monomers as well as enables fast network formation, leading to dramatic polymer property changes including viscosity, cross-linking, vitrification, glass transition temperature, and many others (Bowman, C. N. et al. AlChE J. 2008, 54 (11), 2775-2795). These changes indicate the importance of understanding and controlling the relationship between polymer formation and property development during photopolymerization. Among many parameters, polymerization kinetics depends on monomer/oligomer molecular weight and reactivity, light intensity, and polymerization temperature (Hasa, E. et al. Macromolecules 2019, 52 (8), 2975-2986; Scholte, J. P. et al. J. Polym. Sci. Part A Polym. Chem. 2017, 55 (1), 144-154.; Szczepanski, C. R. et al. Polymer (Guildf). 2012, 53 (21), 4694-4701 and Chatani, S. Polym. Chem. 2014, 5 (7), 2187-2201). For example, introducing non-reactive oligomers into a low molecular weight dimethacrylate system increased the final conversion and delayed maximum conversion rate. These changes in kinetics were attributed to the relatively large oligomer Mₙ and concentration in the formulation which both influence viscosity and diffusion of active centers during UV illumination (Szczepanski, C. R. et al. Polymer (Guildf). 2012, 53 (21), 4694-4701). Therefore, the incorporation of OH-functionalized oligomers into a tetraethylene glycol diacrylate (TTGDA) system should also have a significant impact on photopolymerization kinetics depending on OH groups placement on the oligomer chain. FIG. 2 shows the reaction rate as a function of conversion for the control TTGDA system and for oligomer containing systems during photopolymerization at 10 mW/cm². The system with neat TTGDA reaches the maximum rate relatively quick at around 25% double bond conversion, with a final conversion of nearly 70%. This behavior is typical for highly cross-linked systems which tend to vitrify and terminate relatively quickly (Kloosterboer, J. G. Network Formation by Chain Crosslinking Photopolymerization and Its Applications in Electronics. In Electronic Applications; Springer Berlin Heidelberg: Berlin, Heidelberg, 1988; pp 1-61).

The incorporation of oligomers impacts both the maximum rate and final conversion. Specifically, adding either end or random-functionalized oligomers leads to increased conversion at the maximum rate. Additionally, the final acrylate conversion appears to increase to around 90-95% depending on the oligomer type and Mₙ. Although the oligomer addition helps to increase final conversion, this occurs to a lesser extent in TTGDA/E50k systems likely due to limited diffusion of polymer radicals and self-association E50k oligomer. This effect is not noticed in random-functionalized oligomers perhaps due to more uniform OH group distribution along the oligomer chain, allowing better hydrogen bonding interactions between oligomers and TTGDA network. The increased final and maximum rate conversion can be associated with the increased propagation rate and decreased termination reactions due to limited diffusion of the reactive species (Szczepanski, C. R. et al. Polymer (Guildf). 2012, 53 (21), 4694-4701 and Szczepanski, C. R. et al. Eur. Polym. J. 2015, 67, 314-325). Additionally, previous studies have shown that the presence of hydroxyl groups form a variety of hydrogen bonding which accelerates overall polymerization rate of the acrylate functional groups (Lee, T. Y. et al. Macromolecules 2004, 37 (10), 3659-3665; Beuermann, S. Macromolecules 2004, 37 (3), 1037-1041 and Jansen, J. F. G. A. et al. Macromolecules 2003, 36 (11), 3861-3873).

Polymer Morphology

Variations in photopolymerization kinetics typically indicate significant changes in network gelation, morphological development, and polymer properties (Hasa, E. et al. Macromolecules 2019, 52 (8), 2975-2986; Bowman, C. N. et al. AIChE J. 2008, 54 (11), 2775-2795 and Szczepanski, C. R. Design of Heterogeneous Network Structures Through Polymerization Induced Phase Separation, University of Colorado, 2014). The addition of different oligomers into the TTGDA resin increases final double bond conversion and delays the time to reach the maximum rate, enhancing monomer/oligomer diffusion prior to vitrification which allows greater morphological development. Previous work has shown that increasing the Mₙ of non-reactive oligomers in dimethacrylate (e.g. TEGDMA) systems leads to observable phase separation due to overall reduction of system entropy that increases Gibbs free energy of mixing and thus thermodynamic instability during the course of polymerization (Szczepanski, C. R. et al. Polymer (Guildf). 2015, 70, 8-18). Consequently, it is reasonable to believe that the incorporation of oligomers with different architectures could also lead to thermodynamic instability, tailoring nano/micro-structure formation during photopolymerization and potentially forming distinct phase-separated domains (Scholte, J. P. et al. J. Polym. Sci. Part A Polym. Chem. 2017, 55 (1), 144-154; Szczepanski, C. R. et al. Polymer (Guildf). 2012, 53 (21), 4694-4701 and Szczepanski, C. R. et al. Eur. Polym. J. 2015, 67, 314-325).

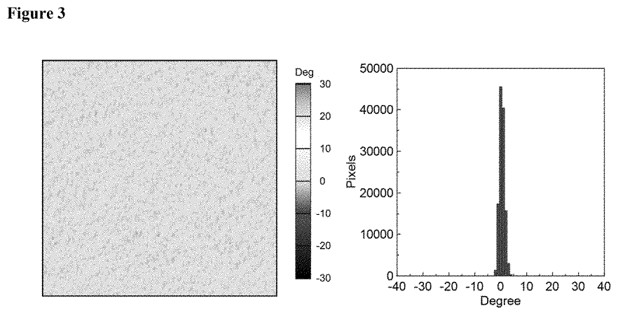

To investigate whether phase-separated domains are created by adding end/random-functionalized oligomers, atomic force microscopy (AFM) was used to examine polymer surface morphology and phase distribution. A more detailed description of AFM operation to detect different phase-separated domains can be found elsewhere (Hasa, E. et al. Macromolecules 2019, 52 (8), 2975-2986). FIG. 3 shows the phase morphology and distribution for the neat TTGDA systems photocured at 10 mW/cm². This system does not exhibit considerable phase contrast and the presence of small variations is due to structural heterogeneities (i.e. regions with high and low cross-linked density), common for highly cross-linked networks (Scholte, J. P. et al. J. Polym. Sci. Part A Polym. Chem. 2017, 55 (1), 144-154).

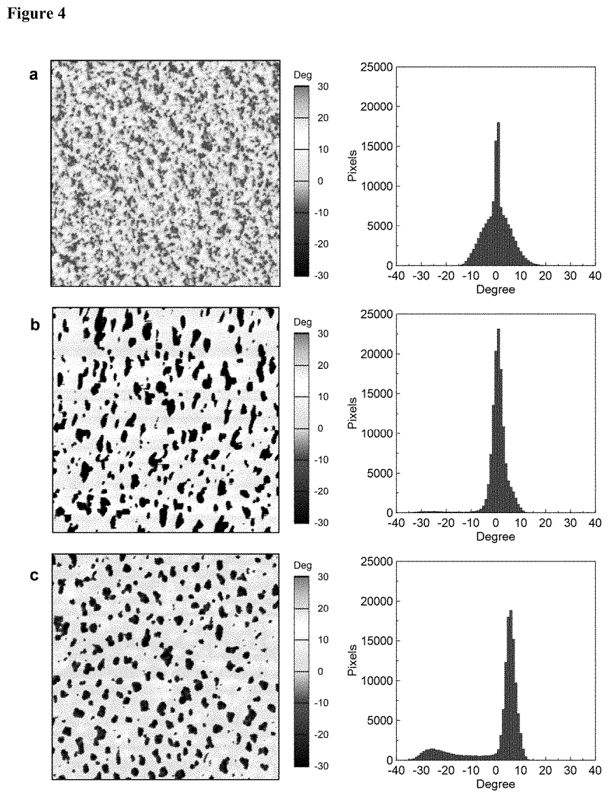

In addition, further information regarding polymer surface morphology is obtained through phase distribution plots. These plots show the number of pixels that exhibit the same local properties (e.g. stiffness, composition, and adhesion) over a certain change of AFM tapping oscillation. Thus, small deviation from the default oscillation indicate formation of single-domain polymers while enhanced deviation shows formation of multi-domain polymers. The phase distribution for the neat TTGDA system appears very narrow indicating single-domain formation. FIG. 4 shows polymer morphologies and phase distributions for photopolymerized systems modified with end oligomers. Specifically, well integrated but distinct phase-separated domains appear to form for the TTGDA/E15k system. In addition, TTGDA systems modified with E30k or E50k exhibit more distinct domains as indicated by the increased phase contrast due to increased oligomer concentration in the systems which likely contributes to a greater degree of phase separation.

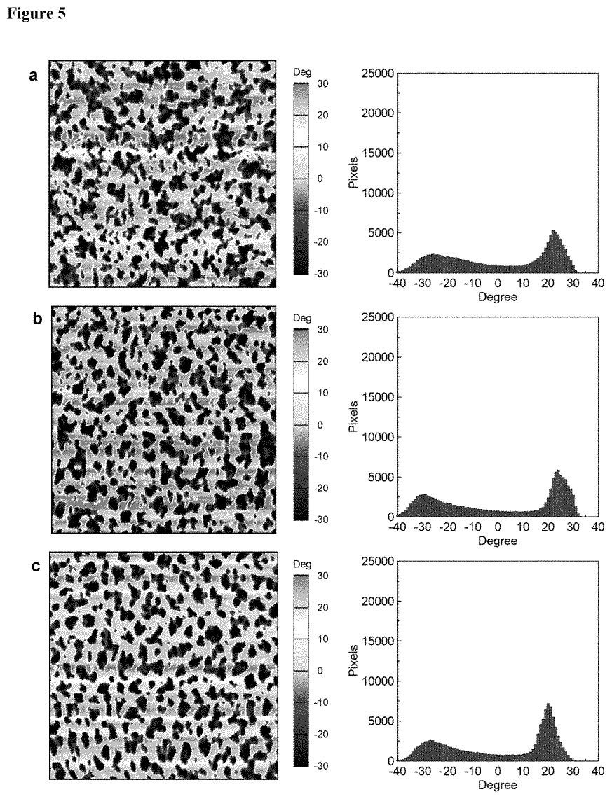

Moreover, phase distributions become more dispersed with increasing oligomer Mₙ. While E15k-modified systems exhibit evenly distributed phases with the short chain length of the linear domains, a second distinct domain appears to form by increasing oligomer Mₙ. This behavior supports that E30k and E50k oligomers tend to promote higher degrees of phase separation due to the occupation of more space within the TTGDA network. On the other hand, polymer morphologies and phase distributions appear much different for systems modified with random-functionalized oligomers as shown in FIG. 5. For example, these systems exhibit significantly increased phase contrast compared to end-functionalized oligomers. Even though increasing the Mₙ appears to induce more distinct domains due to thermodynamically-driven phase separation, the effect of increasing the Mₙ on phase distribution is not as significant as that of end-functionalized oligomers (Szczepanski, C. R. et al. Polymer (Guildf). 2015, 70, 8-18). Additionally, all systems exhibit very broad phase distributions and observable peaks for both negative and positive phase angles. Interestingly, these peaks appear much lower than those for end systems, indicating a larger transition from softer to harder domains. This overall behavior may be related to the random OH group position which likely forms more hydrogen bonds with the polymer network due to oligomer ability to stretch throughout acrylate networks, resulting in more intermixed domains.

Consequently, each oligomer architecture has a different impact on network formation and phase separation during photopolymerization. It is reasonable to believe that end-functionalized oligomers self-associate to a greater degree due to interchain hydrogen bonding between the OH groups as represented in Scheme 1. On the other hand, random-functionalized oligomers may self-associate to a lesser degree because of their more hydrophilic character (random distribution of HEA) which enables better proximity of OH groups to the acrylate network. Furthermore, both oligomer types may also re-arrange/re-initiate during photopolymerization due to oligomer synthesis using a RAFT agent. This RAFT re-initiation could form smaller domains since the oligomer chain may break and re-connect during the cross-linking process.

Thermomechanical Properties

Results indicate that the formulation composition and oligomer architecture can enable various phase-separated polymer morphologies. The formation of continuous and smaller hard/soft phase-separated domains has shown great promise in controlling glass transition temperature (T_{g}) and enhancing Young's modulus and tensile toughness (Hasa, E. et al. Macromolecules 2019, 52 (8), 2975-2986). Therefore, it is expected that the thermal and mechanical behavior of oligomer-modified systems may also change due to formation of observable phase-separated domains with significant variations in phase distribution depending on Mₙ and OH placement.

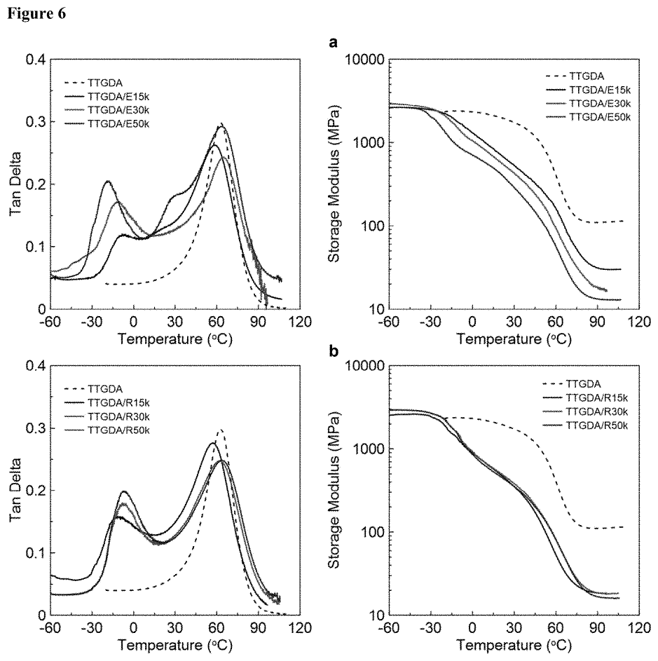

To understand the impact of polymer morphology on thermomechanical properties, tan (δ) behavior and storage modulus were investigated using dynamic mechanical analysis (DMA). Typically, tan (δ) peaks are associated with the T_{g} and can be used to calculate the degree of phase separation, while storage modulus gives information regarding material elasticity and their ability to store energy after undergoing a process (Menard, K. P. DYNAMIC MECHANICAL ANALYSIS A Practical Introduction; 1999 and Lipatov, Y. S. Polym. Bull. 2007, 58 (1), 105-118). FIG. 6 shows the tan (δ) profiles and storage modulus for pure TTGDA and for systems modified with end and random-functionalized oligomers. TTGDA systems exhibit a T_{g} at around 65° C., as indicated by the single tan (δ) peak. Incorporating OH-functionalized oligomers results in the formation of polymers with two tan (δ) peaks. A high temperature tan (δ) peak is observed at around 65° C. likely related to the TTGDA-rich domains and a low temperature tan (δ) peak appears between −15 and −25° C. depending on oligomer type and concentration. This negative T_{g} can be associated with the oligomer-rich domains since all oligomers are synthesized with approximately 80 wt % BA with a reported T_{g} of around −50° C. (Fernandez-Garcia, M. et al. J. Polym. Sci. Part B Polym. Phys. 1999, 37 (17), 2512-2520).

It is important to note that the small shoulder that appears at around 30° C. for TTGDA/E50k systems could be related to the formation of an intermediate region caused either by the network re-arrangement due to RAFT agent or due to significant self-association of this particular oligomer, contributing to slightly different tan (δ) behavior than the other systems. This overall behavior also confirms the fabrication of polymers with phase-separated soft and hard domains as shown in AFM images. Additionally, the peak height of tan (δ) at lower temperatures increases with oligomer Mₙ due to the higher concentration of both linear BA and HEA within the soft domain. These changes in tan (δ) behavior suggest that increasing oligomer Mₙ or changing the OH group placement can significantly impact polymer structure and the degree of phase separation, respectively.

Furthermore, the introduction of oligomers has a significant effect on storage modulus of TTGDA. For pure TTGDA systems, the modulus in the glassy region is almost constant up to temperatures of 10° C., followed by a sharp drop at 60° C. On the other hand, the modulus in the glassy region of oligomer-modified systems remains flat only up to approximately −15° C., followed by a gradual decrease in modulus as the temperature increases. Additionally, the incorporation of oligomers results in a remarkable reduction in the storage modulus of the rubbery plateau by one order of magnitude. While the storage modulus of the rubbery plateau decreases with increasing the Mₙ of end-functionalized oligomers, this does not seem to be the case for random-functionalized oligomers which demonstrate similar behaviors for any Mₙ. Again, this behavior could be due to enhanced self-association of the high Mₙ end-functionalized oligomers which is very common in block type oligomers (Asada, M. et al. Polymer (Guildf). 2016, 105, 172-179). In addition, the overall reduction in storage modulus indicates that the apparent cross-linked density of these systems is much lower than that for neat TTGDA and may be caused by the fast release of energy from the network due to the presence of the linear oligomers (Scholte, J. P. et al. J. Polym. Sci. Part A Polym. Chem. 2017, 55 (1), 144-154).

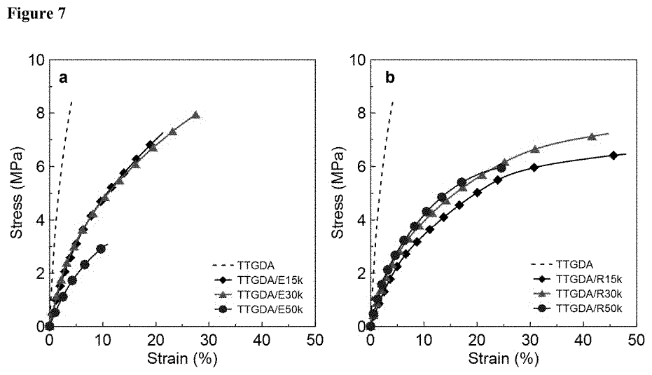

Based on the dramatic changes in tan (δ) and storage modulus behaviors, as well as the formation of polymer networks with multiple T_{g}'s, it is reasonable to believe that each system will exhibit different mechanical properties. To investigate these potential changes in macroscopic properties, stress as a function of strain was evaluated using DMA. FIG. 7 shows stress as a function of strain for TTGDA systems modified with different oligomers. The pure TTGDA shows the highest Young's modulus with a very low elongation at break of approximately 5%. This stress-strain behavior is related to the high cross-link density and the formation of a single-domain network with high T_{g}. Incorporating E15k or E30k into the TTGDA system results in a considerable increase in elongation at break of up to 6 times and a slight decrease in Young's modulus. For TTGDA/E50k systems, elongation at break increases by a factor of 2 compared to the neat TTGDA with further decrease in Young's modulus.

On the other hand, random-functionalized oligomers exhibit a more significant increase in elongation at break compared to that for end-functionalized systems. In this case, the addition of R15k or R30k increases elongation at break by roughly 9 times. When incorporating the oligomer with the highest Mₙ (R50k), the elongation at break appears again to decrease compared to systems with lower Mₙ oligomers, but still nearly 5 times higher than that of pure TTGDA. Moreover, Young's modulus is reduced compared to TTGDA, but maintains similar values for all random-functionalized oligomer systems.

The mechanical behavior of systems modified with OH-functionalized oligomers is likely related to formation of phase-separated soft/hard domains, with the high T_{g} cross-linked domains resisting the initial stress and the low T_{g} linear domains providing the necessary network flexibility that enables additional stretch. However, the formation of more distinct phase-separated domains for systems modified with E50k or R50k has a detrimental effect on elongation at break (reduced values) which may be due to less interactions between the soft oligomer and hard acrylate network likely imparted from different degrees of self-association of each oligomer. Additionally, OH-modified oligomers significantly reduce overall cross-linked density which can account for the decreased Young's modulus.

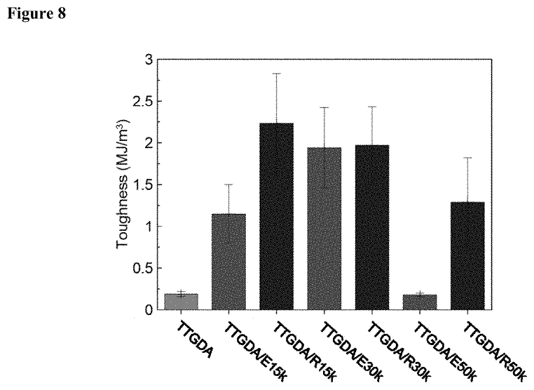

Because of the significant changes in stress and strain behavior imparted form the oligomer addition into TTGDA formulation, these materials should exhibit variations on the amount of absorbed energy before breaking. Prior work has shown that changes in the cross-linking processes for radical/cationic systems resulted in different interactions between the soft and hard domains, leading to enhanced elongation at break, a twofold increase in maximum stress, and significant improvement of tensile toughness and impact strength. In this work, the incorporation of oligomers into the TTGDA system enhances network flexibility and elongation at break, impacts cross-linked density, and forms nano/micro-structured polymers with multiple T_{g}'s and different phase distributions. Based on these morphological and thermomechanical changes, it is reasonable to believe that the oligomer-modified polymers will exhibit enhanced energy absorbance (i.e. toughness) before breaking. FIG. 8 shows polymer toughness for TTGDA systems modified with end/random-functionalized oligomers as calculated from the area under stress-strain curves at 20° C. The pure TTGDA system demonstrates a relatively low toughness of nearly 0.25 MJ/m³ likely due to network brittleness and inconsistency in cross-linked density. As compared to the TTGDA system, polymer toughness demonstrates a 4-fold and 8-fold increase when incorporating E15k and E30k, respectively. End-functionalized oligomers of higher Mₙ (E50k) exhibit similar toughness with pure TTGDA. As for systems modified with random-functionalized oligomers, toughness increases by approximately 9 and 8 times for TTGDA/R15k and TTGDA/R30k systems, respectively. Additionally, the incorporation of R50k leads to a nearly 5-fold increase in toughness.

This significant increase in toughness for TTGDA systems modified with end/random-functionalized oligomers (except E50k) may be due to the presence of well dispersed linear/soft domains within the cross-linked TTGDA domains. As the crack propagation forces develop throughout the polymer network, the presence of oligomer-rich domains prevents further expansion and enhances thermal dissipation. Additionally, it can be assumed that most of the oligomer-modified systems exhibit enhanced toughness due to intermolecular hydrogen bonding between the hydrogen and the strongly electronegative oxygen in the ether and ester groups of TTGDA. The hydroxyl groups can form many types of hydrogen bonds including those between hydroxyl groups as well as between hydroxyl and carbonyl groups with a strength on the order of about 20 kJ/mol (Lee, T. Y. et al. Macromolecules 2004, 37 (10), 3659-3665). This high energy and the formation of different domain distributions via photo-induced phase separation significantly mitigate the propagation of cracks. Although hydrogen bonding and domain flexibility help to enhance mechanical behavior, the usage of E50k oligomer does not increase TTGDA toughness likely due to significantly decreased cross-linked density and reduced interactions between oligomers and polymer network.

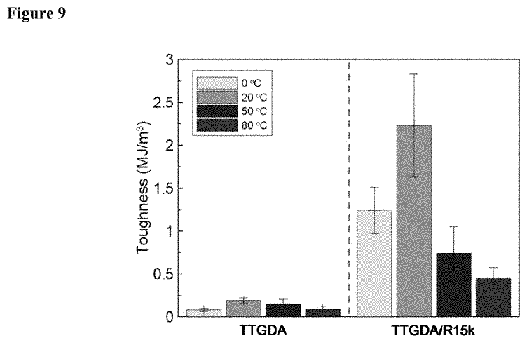

Given the evidence that phase-separated polymers contain both rubbery and glassy regions with different phase distributions, it is reasonable to believe that toughness might significantly change due to variations of chain mobility and the differences in viscoelastic behavior (e.g. tan (δ) and storage modulus) over a wide range of temperature (FIG. 7). To probe any changes in the absorbed energy of single and multi-phase systems, polymer toughness was investigated at different temperatures (0, 20, 50, and 80° C.). These temperatures were selected not only to examine the behavior of these systems at conditions close to lower T_{g}, between the two T_{g}'s, and beyond the higher T_{g} but also to show the performance of phase-separated polymers under dramatic changes in environmental conditions. FIG. 9 shows toughness for neat TTGDA and TTGDA/R15k systems at different temperatures. Toughness of the neat TTGDA systems demonstrates small variations with the highest values observed at 20 and 50° C. When adding R15k, toughness is significantly higher at any specific temperature compared to that of TTGDA. For example, an increase of about 11-fold and 9-fold can be observed at the lowest and room temperatures, respectively.

Additionally, a smaller but still important increase in toughness by a factor 5 is observed at 50 and 80° C. compared to those of the corresponding neat TTGDA. Thus, these phase-separated polymers can absorb the optimum amount of energy before breaking when stress is applied at environmental conditions that fall between the first and second tan (δ) peaks (FIG. 6). This behavior is can be attributed to the network flexibility imparted from the addition of the linear oligomers, the enhanced oligomer chain mobility, and the presence of phase-separated polymers with multiple T_{g}'s which enables multiple glassy and rubbery regions to co-exist at the same network. On the other hand, pure TTGDA systems are very brittle over the examined temperatures with slight mobility of cross-links, leading to insufficient energy absorbance.

Impact Strength of 3D Printed Objects

The addition of OH-functionalized oligomers into the TTGDA resin enables fabrication of unique polymer morphologies, leading to enhanced toughness for almost all systems (expect TTGDA/E50k). To further understand the mechanical/fracture properties of systems composed of PR48 and different oligomers, the impact strength of 3D printed objects was also investigated using Izod impact testing. Impact strength is a more direct measure of material energy absorption before fracture which shows the ability of materials to resist a sudden impact (Campo, E. A. 2—Mechanical Properties of Polymeric Materials. In Selection of Polymeric Materials; Campo, E. A., Ed.; Plastics Design Library; William Andrew Publishing: Norwich, N.Y., 2008; pp 41-101). Previous work has shown that the addition of silicon-modified polyurethane oligomers into a brittle epoxy resin resulted in a 5-fold increase in impact strength due to network flexibility imparted from improved entanglements between oligomers and cross-linked domains (Bhuniya, S. et al. J. Appl. Polym. Sci. 2003, 90 (6), 1497-1506). Therefore, the incorporation of custom-synthesized oligomers could also affect the performance of a highly cross-linked/brittle system such as PR48.

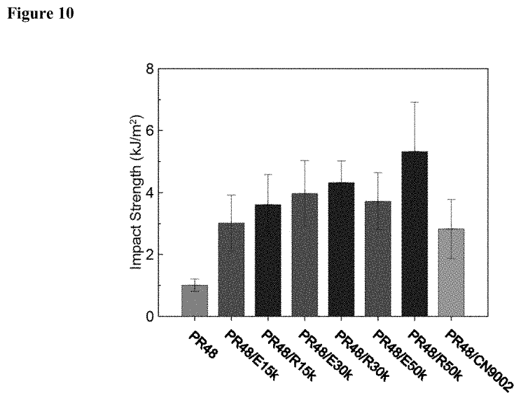

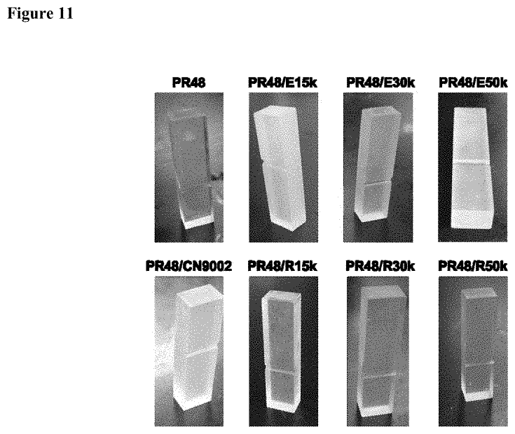

FIG. 10 shows the impact strength of PR48 systems modified with different OH-functionalized oligomers and CN9002. It is important to note that all objects were UV post-cured at 20 mW/cm² for 10 minutes using a 405 nm LED lamp in order to ensure complete polymerization of the remaining carbon double bonds. Photos of 3D printed objects where PR48 is very clear, while PR48/oligomer systems appear less transparent likely due to some degree of phase separation (FIG. 11). Moreover, PR48 systems modified with OH-functionalized oligomers exhibit yellowness due to the RAFT agent used in the synthesis. Incorporation of oligomers into the PR48 system results in a significant increase in impact strength. For example, the addition of E15k or E30k oligomers results in an increase of up to a 4-fold in impact strength. For E50k-modified systems, impact strength appears to slightly decrease compared to the oligomers with lower Mₙ. The addition of random-functionalized oligomers exhibits slightly different behavior. In this case, impact strength gradually increases by 3.5, 4.5, and 5.5-fold by using R15k, R30k, and R50k, respectively.

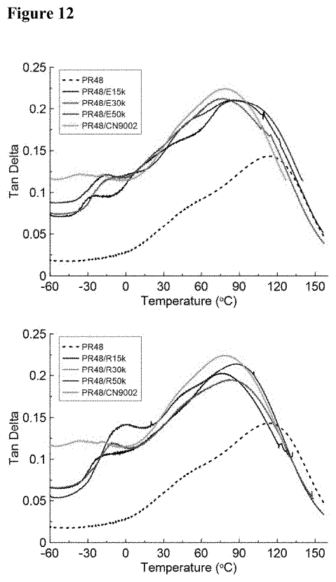

Interestingly, incorporating CN9002 increases impact strength of PR48 approximately by a factor of 3. The impact strength of about 2.8 kJ/m² of PR48/CN9002 system not only is lower than those of all systems modified with OH-functionalized oligomers but also half the value of PR48/R50k system. This more remarkable increase in impact strength for systems with custom-synthesized oligomers may be associated with the formation of phase-separated and well-dispersed soft/hard domains in the polymer network as indicated by the multiple tan (δ) peaks shown in FIG. 12. In addition, the OH groups likely form various hydrogen bonds which enhances intermolecular strength and interlayer adhesion.

These results validate our hypothesis that incorporation of linear oligomers with different Mₙ and OH group placements can significantly alter polymer morphology and properties. Using photo-induced phase separation helps to fabricate polymer morphologies with various domain distributions and hydrogen bonding interactions, leading to highly cross-linked but flexible polymer networks with improved toughness and impact strength.

This study shows that OH-functionalized oligomers can be used to form separate soft domains within glassy highly cross-linked acrylate systems, generating polymers with controlled thermo-mechanical properties. The OH group placement and oligomer Mₙ play an important role in the degree of phase separation and domain distribution. Tan (δ) profiles reveal that increasing the Mₙ results in more distinct phase-separated domains, as indicated by the oligomer-rich tan (δ) peak height, which is more distinct for the end-functionalized oligomers due to self-association. The random-functionalized oligomers appear to interact to a greater degree with the acylate network during photopolymerization, leading to more diverse/intermixed domains. These interactions between the acrylate networks and oligomer domains enable significant enhancement of elongation at break, especially for random-functionalized oligomers due to better hydroxyl group distribution and thus hydrogen bonding between oligomers and the polymer network. This behavior contributes to significantly improved toughness at a range of temperatures. In addition, including OH-functionalized oligomers into a model acrylate formulation significantly improves the impact strength of 3D printed objects by up to a 5.5-fold and almost double that observed with the commercial CN9002 oligomer system. The above work shows that controlling the architecture of OH-functionalized oligomers can impact the domain distribution of phase-separated morphologies, resulting in much tougher polymers that can be used for a range of applications including 3D printing.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A composition comprising a crosslinked polymer network and one or more oligomers that are substituted with one or more polar groups.

2. The composition of claim 1 wherein the crosslinked polymer network comprises a polymer selected from the group consisting of polyacrylates, polymethacrylates, polyurethane acrylate, polyurethane methacrylates, polyacrylamides, polymethacrylamides, polythiols, polystyrenes, and polyvinyl ethers.

3. The composition of claim 1, wherein the crosslinked polymer network comprises domains that contain one or more oligomer.

4. The composition of claim 1, wherein the crosslinked polymer network is derivable from polymerization of tetraethyleneglycol diacrylate.

5. The composition of claim 1, wherein the polar groups are each independently selected from group consisting of hydroxy, mercapto, —NR₂, and —O—C(═O)—NR₂, wherein each R is independently selected from the group consisting of H and (C₁-C₆)alkyl.

6. The composition of claim 1, wherein the one or more oligomers each independently have a molecular weight in the range of from about 10,000 amu to about 60,000 amu.

7. The composition of claim 1, wherein the one or more oligomers are each independently a block co-polymer.

8. The composition of claim 1, wherein the one or more oligomers are derivable from the polymerization of (C₁-C₈)alkyl acrylate and substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl.

9. The composition of claim 1, wherein the one or more oligomers are derivable from the polymerization of butyl acrylate and hydroxyethyl acrylate.

10. The composition of claim 1, wherein the one or more oligomers are block co-polymers that are derivable from the polymerization of (C₁-C₈)alkyl acrylate and substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl;
wherein the blocks derivable from the (C₁-C₈)alkyl acrylate make up from about 10% to about 90% of the oligomer by weight and the blocks derivable from the substituted (C₁-C₈)alkyl acrylate make up from about 10% to about 90% of the oligomer by weight.

11. The composition of claim 10, wherein the blocks derivable from the (C₁-C₈)alkyl acrylate make up from about 40% to about 80% of the oligomer by weight and the blocks derivable from the substituted (C₁-C₈)alkyl acrylate make up from about 20% to about 60% of the oligomer by weight.

12. The composition of claim 10, wherein the blocks derivable from the (C₁-C₈)alkyl acrylate make up from about 60% to about 80% of the oligomer by weight and the blocks derivable from the substituted (C₁-C₈)alkyl acrylate make up from about 20% to about 40% of the oligomer by weight.

13. The composition of claim 8, wherein each oligomer independently has the structure of formula (I):
(B)u(A)v(B)u(A)v(B)u(A)v(B)u(A)v(B)u(A)v(B)u(A)v(B)u(A)v(B)u(A)v(B)u (I)
wherein:
each B is derivable from (C₁-C₈)alkyl acrylate;
each A is derivable from a substituted (C₁-C₈)alkyl acrylate, wherein the (C₁-C₈)alkyl of each substituted (C₁-C₈)alkyl acrylate is optionally independently substituted with one or more groups independently selected from group consisting of hydroxy, mercapto, —NR₂, and —O—C(═O)—NR₂, wherein each R is independently selected from the group consisting of H and (C₁-C₆)alkyl;
each u is an integer from 0 to 50;
each v is an integer from 0 to 50; and
the sum of all u and all v together is less than 1000.

14. The composition of claim 1 that has an impact strength that is at least about 5-times as great as the impact strength of the same crosslinked polymer in the absence of the one or more oligomers.

15. The composition of claim 1 that has a tensile toughness that is at least about 8-times as great as the tensile toughness of the same crosslinked polymer in the absence of the one or more oligomers.

16. The composition of claim 1 that has an elongation to break that is at least about 8-times as great as the elongation to break of the same crosslinked polymer in the absence of the one or more oligomers.

17. A printable ink comprising a composition as described in claim 1.

18. An article of manufacture that comprises a composition as described in claim 1.

19. A method comprising: forming a crosslinked polymer network in the presence of one or more oligomers that are substituted with one or more polar groups to provide a final composition that comprises a polymer network and one or more oligomers that are substituted with one or more polar groups.

20. A solution comprising acrylate, methacrylate, urethane acrylate, urethane methacrylate, acrylamide, methacrylamide, thiol, styrene, or vinyl ether monomers, and oligomers that are substituted with one or more polar groups.
